(19) United States
(12) Patent Application Publication
(10) Pub. No.: US 2010/0101983 A1
(43) Pub. Date: Apr. 29, 2010

(54) FLOW SORTING OF NANOMATERIALS

(76) Inventors: Jason Edward Butler, Gainesville, FL (US); Kirk Jeremy Ziegler, Gainesville, FL (US)

Correspondence Address: MH2 TECHNOLOGY LAW GROUP, LLP, 1951 KIDWELL DRIVE, SUITE 550, TYSONS CORNER, VA, 22182, US

(21) Appl. No.: 12/527,317

(22) PCT Filed: Feb. 14, 2008
(86) PCT No.: PCT/US08/53927

§ 371 Date: Aug. 14, 2009

Related U.S. Application Data
(60) Provisional application No. 60/890,113, filed on Feb. 15, 2007.

(51) Int. Cl. B07C 5/08; D01F 9/12; B01D 57/02; B07C 5/00; G01J 1/58

(52) U.S. Cl. 209/552; 423/447.1; 204/450; 204/547; 204/600; 209/606; 250/459.1; 977/742; 977/750; 977/845

(57) ABSTRACT

In accordance with the invention there are systems and methods of separating a mixture of carbon nanotubes comprising dispersing carbon nanotubes into a fluid to form a dispersion of individually-suspended carbon nanotubes and focusing the dispersion of individually-suspended carbon nanotubes into a single file stream of carbon nanotubes. The methods can also include characterizing the single file stream of carbon nanotubes and sorting the carbon nanotubes based on their properties.

### CROSS-REFERENCE TO RELATED APPLICATION

This application claims priority to U.S. Provisional Patent Application Ser. No. 60/890,113 filed on Feb. 15, 2007, and is a national phase application of PCT/US08/053,927 filed on Feb. 14, 2008, the disclosure of which is incorporated by reference herein in its entirety.

### FIELD OF THE INVENTION

The subject matter of this invention relates to methods of separating nanomaterials. More particularly, the subject matter of this invention relates to methods and systems for detecting and separating carbon nanotubes.

### BACKGROUND OF THE INVENTION

Single-walled carbon nanotubes (SWNTs) are long, hollow tubular molecules of carbon with walls just one atom thick. Since the discovery of SWNTs in 1993 by Iijima, these structures have attracted attention because of their mechanical strength, chemical inertness, and electronic properties. SWNTs consist of a graphene layer rolled into a seamless tubular structure. The properties of single-walled carbon nanotubes (SWNTs) make them ideal for developing and improving alternative energy sources, such as fuel cells, supercapacitors, hydrogen storage, batteries, and transport grids. However, SWNTs have not been widely integrated into commercial products and devices. Perhaps the largest impediment is the necessity of working with mixtures of different types of carbon nanotubes. Synthesis techniques produce approximately 30 different (n,m) types, with about ⅓ being metallic and the remaining about ⅔ being semiconducting. Small differences in the crystallinity of the SWNTs or the angle (chirality) by which the graphene layer is wrapped into a seamless nanotube, are responsible for the metallic versus semiconducting properties. Although limited progress in separating metallic from semiconducting SWNTs has been demonstrated, there is no separation technique available that can achieve a specific (n,m) SWNT type with high fidelity.

Accordingly, the present invention solves these and other problems of the prior art to provide a new method and a system for separating carbon nanotubes, such as single walled and multi-walled, by one or more of specific (n,m) types, their length, their diameter, and number of shells.

### SUMMARY OF THE INVENTION

In accordance with the invention, there is method of separating a mixture of carbon nanotubes. The method can include dispersing carbon nanotubes into a fluid to form a dispersion of individually-suspended carbon nanotubes and focusing the dispersion of individually-suspended carbon nanotubes into a single file stream of carbon nanotubes. The method can also include characterizing the single file stream of carbon nanotubes and sorting the carbon nanotubes based on their properties.

According to another embodiment of the present invention there is a system for separating a mixture of carbon nanotubes. The system can include at least one hydrodynamically focused flow system. The hydrodynamically focused flow system can include a first channel for injecting a dispersion of individually-suspended carbon nanotubes and a second channel for injecting a solvent fluid to focus the dispersion of individually-suspended carbon nanotubes into a single file stream of carbon nanotubes. The system can also include at least one detection system and at least one collection system.

According to yet another embodiment of the present invention, there is a system for separating a mixture carbon nanotubes. The system can include a plurality of microfluidic chips, wherein each of the plurality of microfluidic chips can include a focused flow system, a detection system, and a collection system, wherein each of the plurality of microfluidic chip detects and sorts carbon nanotubes by their properties.

Additional advantages of the embodiments will be set forth in part in the description which follows, and in part will be obvious from the description, or may be learned by practice of the invention. The advantages will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate embodiments of the invention and together with the description, serve to explain the principles of the invention.

### BRIEF DESCRIPTION OF THE DRAWINGS

FIG. 1 depicts a system of nomenclature for carbon nanotubes.

FIG. 2 shows the distributions of (n,m) types present in a typical single walled carbon nanotubes sample.

FIG. 3 is a schematic illustration of an exemplary hydrodynamic focusing device including a core-sheath flow geometry used within modern flow cytometers.

FIG. 4 is a schematic illustration of an exemplary hydrodynamic focusing device according to various embodiments of the present teachings.

FIG. 5 is a schematic illustration of an exemplary flow-through particle sorter for separating single walled carbon nanotubes according to various embodiments of the present teachings.

FIG. 6 is a schematic illustration of an exemplary system for separating nanomaterials in accordance with various embodiments of the present teachings.

FIG. 7 depicts single walled carbon nanotubes fluorescence emission from multiple single walled carbon nanotubes types excited with 660 nm laser.

FIG. 8 is a schematic illustration of an exemplary system for separating a mixture of carbon nanotubes in accordance with various embodiments of the present teachings.

FIG. 9 is a schematic illustration of an exemplary system for separating a mixture of carbon nanotubes in accordance with various embodiments of the present teachings.

FIG. 10 shows a method of separating a mixture of carbon nanotubes in accordance with various embodiments of the present teachings.

FIGS. 11A-11D schematic illustrates an exemplary flow through-sorter for removing metallic single walled carbon nanotubes from a mixture of carbon nanotubes, according to various embodiments of the present teachings.

### DESCRIPTION OF THE EMBODIMENTS

Reference will now be made in detail to the present embodiments, examples of which are illustrated in the accompanying drawings. Wherever possible, the same reference numbers will be used throughout the drawings to refer to the same or like parts.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less that 10” can assume negative values, e.g. −1, −2, −3, −10, −20, −30, etc.

As used herein, the term “carbon nanotube” is used interchangeably with the terms including single walled carbon nanotube and multi walled carbon nanotube. Also, as used herein, the term “multi walled carbon nanotube” includes double walled carbon nanotube.

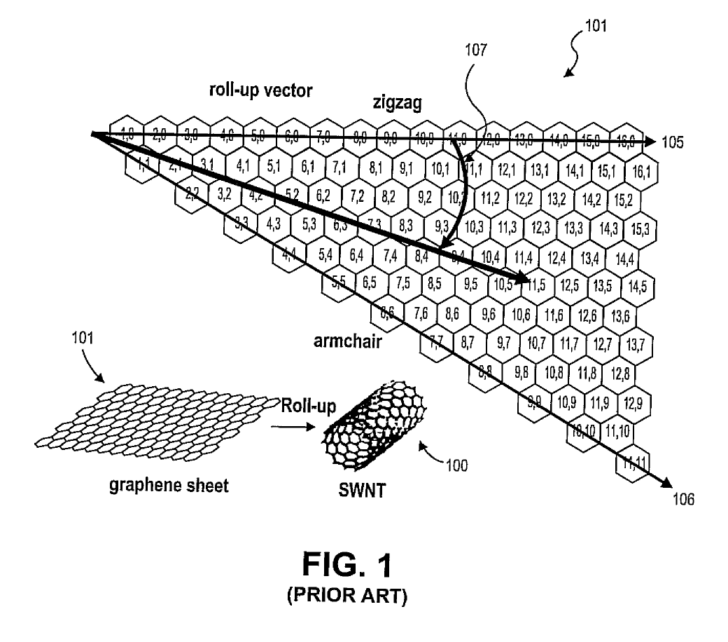

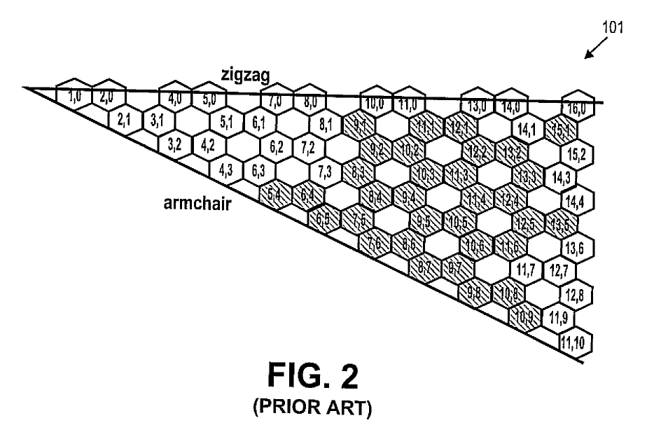

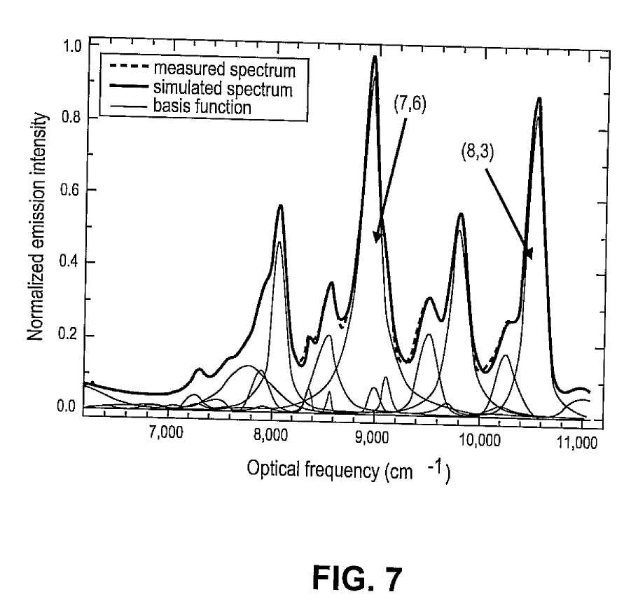

FIG. 1 depicts a system of nomenclature for single walled carbon nanotubes (SWNTs) 100. The structure of single walled carbon nanotubes (SWNTs) 100 can be described as a graphene layer 101 rolled into a seamless tubular structure. However, the graphene layer 101 can be rolled at different vectors around the circumference of the nanotubes 100 labeled by the indices (n,m) as shown in FIG. 1. The integers n and m denote the number of unit vectors along two directions 105, 106 in the honeycomb crystal lattice of graphene 101 and α denote the chiral angle 107. If m=0, the resultant nanotubes (n,0) are called “zigzag”. If n=m, the resultant nanotubes (n,n) are called “armchair”. The rest are called “chiral”. These different vectors or chiralities have important implications for the electronic structure of the SWNTs 100. The transformation of graphene 101 to nanotubes 100 introduces new boundary conditions that affect the band structure of graphene 101 resulting in different electrical properties for each nanotube 100. SWNT synthesis often results in about 30 to about 40 different (n,m) types with approximately ⅓^{rd} metallic and ⅔^{rd} semiconducting as shown in the FIG. 2. The semiconducting (n,m) types have hatchings in FIG. 2. The metallic SWNTs satisfy the condition |n−m|=3q or 2n+m=3q, where q is an integer; the remaining SWNTs are semiconducting with geometry-dependent bandgaps. Thus, all armchair (n=m) nanotubes are metallic, and nanotubes (5,4), (6,4), (9,1), etc. are semiconducting, as shown in FIG. 2. Each semiconducting SWNT has a unique band gap related to the electronic states which exhibit sharp van Hove singularities similar to molecular density of states and therefore, each (n,m) type can have an optimum excitation energy for fluorescence. A person of ordinary skill in the art would know that a 660 nm and a 785 nm excitation source can be sufficient to excite most semiconducting SWNTs. Furthermore, the fluorescence intensity signal from the SWNTs can be maximized by aligning the SWNTs parallel to the polarization of the laser light whereby individual SWNTs can undergo excitation of the E₂₂ van Hove transitions polarized along the SWNT axis. The emission energies of a specific (n,m) SWNT varies slightly because of changes in the structure and local environment. FIG. 7 depicts single walled carbon nanotubes fluorescence emission from multiple single walled carbon nanotubes types excited with 660 nm laser.

Though, some progress has been made in separating SWNTs, these approaches suffer from poor yields or elaborate, time-consuming batch iterations. Continuous processes are typically preferred in industry because they provide higher throughputs, reduced costs, and improved efficiencies.

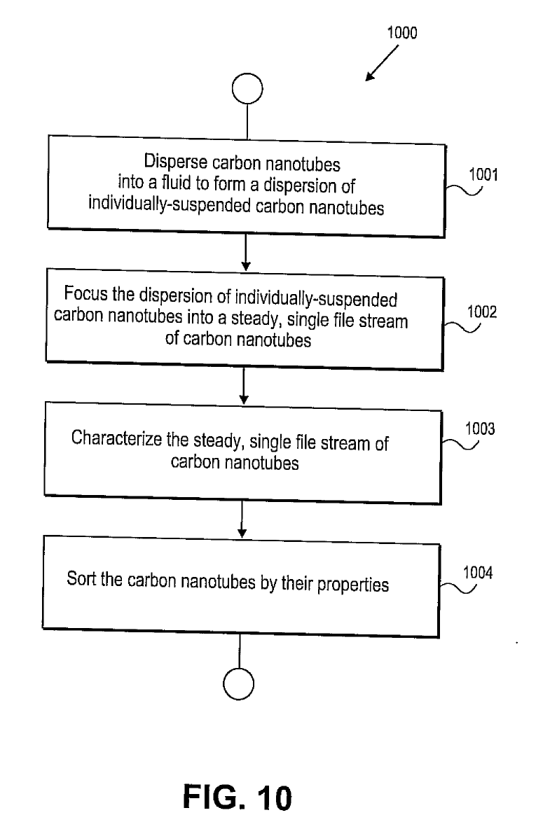

According to various embodiments, there is a method 1000 of separating a mixture of carbon nanotubes, as shown in FIG. 10. The method 1000 can include dispersing carbon nanotubes into a fluid to form a dispersion of individually-suspended carbon nanotubes, as in step 1001. In some embodiments, the step 1001 of dispersing carbon nanotubes into a fluid can include dispersing one or both of a mixture of (n,m) single walled carbon nanotubes 100 and a mixture of multi walled carbon nanotubes (not shown) into the fluid. In other embodiments, the step 1001 of dispersing a mixture of (n,m) single walled carbon nanotubes 100 into a fluid can include dispersing a mixture of metallic single walled carbon nanotubes and semiconducting single walled carbon nanotubes into the fluid. The method 1000 can also include focusing the dispersion of individually-suspended carbon nanotubes into a single file stream of carbon nanotubes, as in step 1002. The method 1000 can further include characterizing the single file stream of carbon nanotubes, as in step 1003 and sorting the carbon nanotubes based on their properties, as shown in step 1004. In various embodiments, the step 1004 of sorting the carbon nanotubes based on their properties can include sorting the carbon nanotubes based on specific (n,m) types. In other embodiments, the step 1004 of sorting the carbon nanotubes based on their properties can include sorting the carbon nanotubes by one or more of their length, their diameter, and number of shells.

A dispersion of individually-suspended carbon nanotubes in a fluid such as water can be obtained by surfactant stabilization. Any suitable method can be used to form a dispersion of one or both of a mixture of (n,m) single walled carbon nanotubes (SWNTs) 100 and a mixture of multi walled carbon nanotubes (not shown). An exemplary surfactant dispersion of individually-suspended SWNTs in water can be prepared by first high-shear mixing of the SWNT bundles in about 1 weight % to about 2 weight % surfactant solution for about 30 minutes to about 90 minutes, then ultrasonicating for about 10 minutes to about 30 minutes at about 15 kHz to about 25 kHz, and centrifuging at about 100,000 g to about 200,000 g for about 3 hours to about 5 hours. The centrifugation can remove most SWNT bundles and metal impurities and can yield a supernatant solution of micelle-suspended individual SWNTs which can fluoresce. These suspensions can be stable for weeks with typical concentrations of about 15 mg/L to about 25 mg/L. Various anionic, cationic, and nonionic surfactants and polymers can be used for suspending SWNTs in water. Non limiting examples of anionic surfactants include, but are not limited to SARKOSYL® NL surfactants such as N-lauroylsarcosine sodium salt, N-dodecanoyl-N-methylglycine sodium salt, and sodium N-dodecanoyl-N-methylglycinate; polystyrene sulfonate (PSS); sodium dodecyl sulfate (SDS); sodium dodecyl sulfonate (SDSA); sodium dodecylbenzene sulfate (SDBS); and sodium alkyl allyl sulfosuccinate (TREM). Non limiting examples of cationic surfactants include, but are not limited to dodecyltrimethylammonium bromide (DTAB), cetyltrimethylammonium bromide (CTAB), and cetyltrimethylammonium chloride (CTAC). Non limiting examples of nonionic surfactants include, but are not limited to SARKOSYL® L surfactants such as N-lauroylsarcosine and N-dodecanoyl-N-methylglycine); BRIJ® surfactants such as polyethylene glycol dodecyl ether, polyethylene glycol lauryl ether, polyethylene glycol hexadecyl ether, polyethylene glycol stearyl ether, and polyethylene glycol oleyl ether; PLURONIC® surfactants; TRITON®-X surfactants such as alkylaryl polyethether alcohols, ethoxylated propoxylated C₈-C₁₀ alcohols, t-octylphenoxypolyethoxyethanol, polyethylene glycol tert-octylphenyl ether, and polyoxyethylene isooctylcyclohexyl ether; TWEEN® surfactants such as polyethylene glycol sorbitan monolaurate, polyoxyethylene monostearate, polyoxyethylenesorbitan tristearate, polyoxyethylenesorbitan monooleate, polyoxyethylenesorbitan trioleate, and polyoxyethylenesorbitan monopalmitate; polyvinylpyrrolidone (PVP); and gum Arabic.

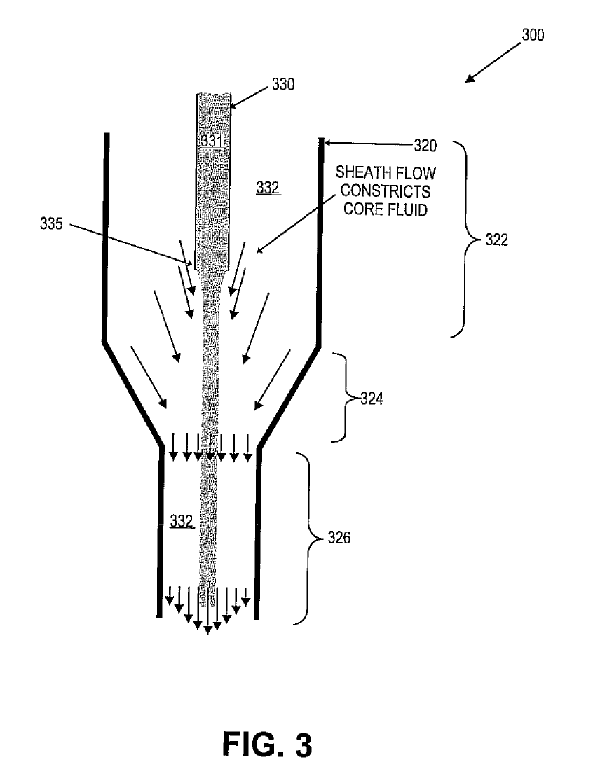

According to various embodiments, the step 1002 including focusing of the dispersion of individually-suspended carbon nanotubes into a single file stream of carbon nanotubes 100 can include hydrodynamic focusing as shown in FIG. 3. FIG. 3 shows a schematic illustration of an exemplary hydrodynamic focusing device 300 including a core-sheath flow geometry similar to that in a modern cell flow cytometers. The hydrodynamic focusing device 300 including a core-sheath flow geometry can include a first channel 330 and a second channel 320. In some embodiments, the first channel 330 can be at least partially disposed inside the second channel 320, as shown in FIG. 3. The second channel 320 can include a sheath flow region 322 having a first diameter, a measurement region 326 having a second diameter smaller than the first diameter, and a neckdown region 324 connecting the sheath flow region 322 to the measurement region 326. In the core-sheath flow geometry, a dispersion of individually-suspended carbon nanotubes 331 also known as core fluid 331 can be slowly injected through the first channel 330 into the center of the sheath flow region 322 of the second channel 320 through which solvent fluids can flow at a relatively high rate. The solvent fluids 332 can flow at an average linear velocity of about 10 micron/second to about 10 cm/second. The flow of solvent fluids 332 in a sheath flow can constrict the core fluid 331 and can convect the individual carbon nanotubes 100 downstream through the neckdown region 324 into the measurement region 326 where measurements can be made on the individual carbon nanotubes 100. In some embodiments, the solvent fluid 332 can be a surfactant solution used to disperse carbon nanotubes. In other embodiments, the solvent fluid 332 can be an immiscible liquid.

The hydrodynamic focusing of the dispersion of individually-suspended carbon nanotubes 331 can ensure that the individual carbon nanotubes 100 pass at regular and rapid intervals through a measurement region 326 with a high degree of precision for characterization.

The first channel 330 can have a diameter from about 50 μm to about 200 μm. This size range can allow reliable passage of carbon nanotubes 100 through the hydrodynamic focusing device 300, but is small enough that the velocities can be maintained at a high, laminar flow rate. The smaller size of the carbon nanotubes 100 can be advantageous as compared to biological cells used in the modern cell flow cytometers, as higher velocities can be obtained while maintaining a laminar flow. However, the smaller size of the carbon nanotubes 100 can also negatively impact the focusing operation, as the carbon nanotubes 100 can be slightly Brownian. Consequently, the carbon nanotubes 100 need to be convected as quickly as possible from the exit 335 of the first channel 330 to the measurement region 326 before random fluctuations disturb the position. This can require high flow rates and minimal distance between the exit 335 of the first channel 330 and measurement region 326, i.e. minimal neckdown region 324. The flow rate can be from about 10 μm/second to about 10 cm/second. The neckdown region 324 can be from about 0.5 cm to about 1.5 cm in length. Alignment of the carbon nanotubes 100, along the second channel 320 or flow direction can also be important for maximizing the fluorescence from the carbon nanotubes 100. A person of ordinary skill in the art would know that alignment issues can be addressed by modifying the exit 335 tip of the first channel 330.

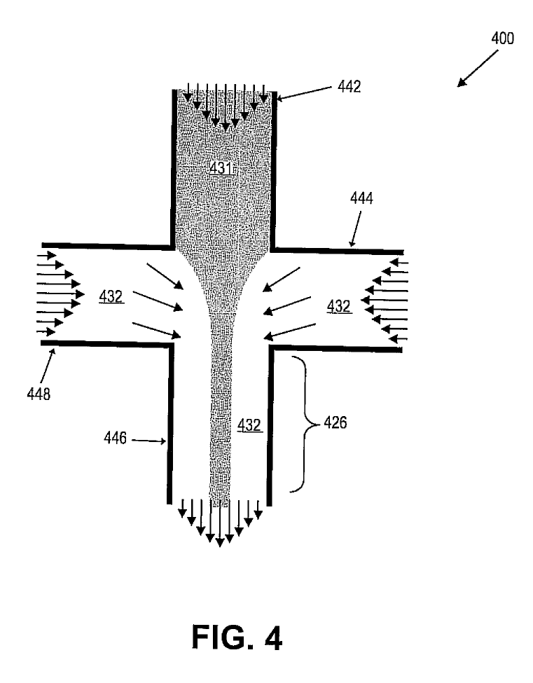

FIG. 4 shows a schematic illustration of a hydrodynamic focusing device 400 including a variation on the core-sheath geometry according to various embodiments of the present teachings. The hydrodynamic focusing device 400 can include four channels, a first channel 442 having a first diameter, a second channel 444 having a second diameter, a third channel 448 having a third diameter, and a fourth channel 446 having a fourth diameter, wherein the first channel 442 and the fourth channel 446 are at an angle to the second channel 444 and the third channel 448. In some embodiments, the first diameter, the second diameter, the third diameter, and the fourth diameter can all be same. In some other embodiments, one or more of the first diameter, the second diameter, the third diameter, and the fourth diameter can be different. In some embodiments, the first channel 442 and the fourth channel 446 can be at about 90° to the second channel 444 and the third channel 448. In some other embodiments, the first channel 442 and the fourth channel 446 can be at an angle from about 0° to about 180° to the second channel 444 and the third channel 448. In the hydrodynamic focusing device 400, a dispersion of individually-suspended SWNTs 431 can be slowly injected through the first channel 442 and a solvent fluid 432 can be introduced through the second channel 444 and the third channel 448 at a relatively high rate. The solvent fluid 432 can flow at an average linear velocity of about 10 μm/second to about 10 cm/second. The extensional flow generated by the solvent fluid 432 in the tee cross-section can orient the carbon nanotubes 100 with the flow direction. If the flow through the second channel 444 and third channel 448 can be well-balanced, the impinging flow in the measurement region 426 can also position the carbon nanotubes 100 in the center of the fourth channel 446. A person skilled in the art would know that separate pumps can be used for each impinging flow through each channel 442, 444, 448 to account for hydrodynamic variances. In some embodiments, the solvent fluid 432 can be a surfactant solution used to disperse carbon nanotubes. In other embodiments, the solvent fluid 432 can be an immiscible liquid.

Each of the four channels 442, 444, 446, 448 can have a width from about 10 μm to about 500 μm. Since the carbon nanotubes 100 must be “focused” at a point, rather than on a plane, the height can be relevant. There are various ways to ensure focusing at a point. In some embodiments, the four channels 442, 444, 446, 448 with a sufficiently thin cross section can be used. In other embodiments, the cross section of the channel 446 can be reduced in the measurement region 426. Yet, in some other embodiments, impinging streams of solvent fluid 432 can be introduced from the top, bottom, and sides.

In various embodiments, the step 1002 of the focusing the dispersion of individually-suspended carbon nanotubes can include auto-focusing by one or more of hydrodynamic interactions of the carbon nanotubes with the channel walls and non-Newtonian Fluid migration mechanisms.

In other embodiments, the focusing of the dispersion of individually-suspended carbon nanotubes 431 into a single file stream of carbon nanotubes 100 can include electrophoretic manipulation. In some other embodiments, the focusing of the dispersion of individually-suspended carbon nanotubes 431 into a single file stream of carbon nanotubes 100 can include dielectrophoretic manipulation. The electrophoretic manipulation and the dielectrophoretic manipulation can include electrodes within the channel 446 that can direct the dispersion of individually-suspended carbon nanotubes 431 to a centerline.

In various embodiments, in the measurement region 326, 426 of the hydrodynamic focusing device 300, 400, a parallel, nonscanning detector (not shown) can be used for detecting carbon nanotubes motions, viewing carbon nanotubes flow profiles, and for analyzing the flow characteristics. In other embodiments, a high-speed InGaAs camera can be used for imaging the flow profiles of SWNTs. Exemplary near-infrared camera include OMA-V (Princeton Instruments Inc., Trenton, N.J.) which can have a quantum efficiency of about 50% to about 80% and can be cryogenically cooled with liquid nitrogen to minimize dark current and to yield excellent near-infrared sensitivity. OMA-V can have high resolution for imaging carbon nanotubes and can provide integration times of 20 μs for fast detection even at elevated flow rates.

Referring back to the method 1000 of separating a mixture of carbon nanotubes, the method 1000 can include characterizing the single file stream of carbon nanotubes as in step 1003 and sorting the carbon nanotubes by their properties, as in step 1004. In various embodiments, the step 1003 of characterizing the single file stream of carbon nanotubes 100 can include exciting each of the carbon nanotubes with multiple sources of excitation including one or more of the same wavelength or different wavelength, collecting one or more of a fluorescence signal, a Raman signal, a Rayleigh signal, and an absorption signal from each of the carbon nanotubes, and analyzing one or more of the fluorescence signal, the Raman signal, the Rayleigh signal, and the absorption signal to determine one or more of a (n,m) type, a length, a diameter, and a number of shells of each of the carbon nanotubes.

In some embodiments, characterizing the carbon nanotubes 100 can include exciting each of the carbon nanotubes with an excitation source including a desired wavelength of light, collecting a fluorescence signal from each of the SWNTs, and analyzing the fluorescence signal to determine one or more of a (n,m) type, a length, a diameter, and a number of shells of each of the carbon nanotubes. Single walled carbon nanotubes (SWNTs) 100 emit fluorescence in the near infrared region, thereby can provide high discrimination against background noise and can reduce signal to noise ratio. Furthermore, time dependent fluorescence of a carbon nanotube can have a substantially constant amplitude on a timescale of 40 ms to 100 s.

In some embodiments, the excitation source can be a 660 nm laser. In other embodiments, the excitation source can be a 785 nm laser. In some other embodiments, the excitation source can be a tunable laser. In various embodiments, a high power output laser (>25 mW) can be used for the excitation source. The higher excitation intensities can lead to higher emission intensities allowing shorter data acquisition times into the low millisecond range, and shorter data acquisition times can allow increased flow rates and higher throughputs. In some other embodiments, the laser can be focused to increase the excitation intensity to the kW/cm² range. In some other embodiments, the laser spot size can be chosen to ensure excitation of the entire flow stream to minimize background noise from scattering while maximizing the carbon nanotubes fluorescence signal.

In various embodiments, a photomultiplier tube (PMTs) can be used for detecting fluorescence signal of the carbon nanotubes. In some embodiments, a photodiode can be used for detecting fluorescence signal of carbon nanotubes. Yet, in some other embodiments, a cryogenically cooled avalanche photoconductive photodiode array can be used detecting fluorescence signal of the carbon nanotubes.

In various embodiments, the step 1003 of characterizing the single file stream of carbon nanotubes 100 including the step of collecting a fluorescence signal from each of the carbon nanotubes can further include determining emission intensity threshold values and detecting a specific carbon nanotubes (n,m) type passing through the measurement zone 326, 426 based on the emission intensity threshold values. The emission intensity threshold values can be determined by collecting statistics for the single-molecule carbon nanotubes fluorescence of each (n,m) type. In some embodiments, a carbon nanotube with a specific length, or a diameter, or a number of shells can be detected based on the emission intensity threshold values.

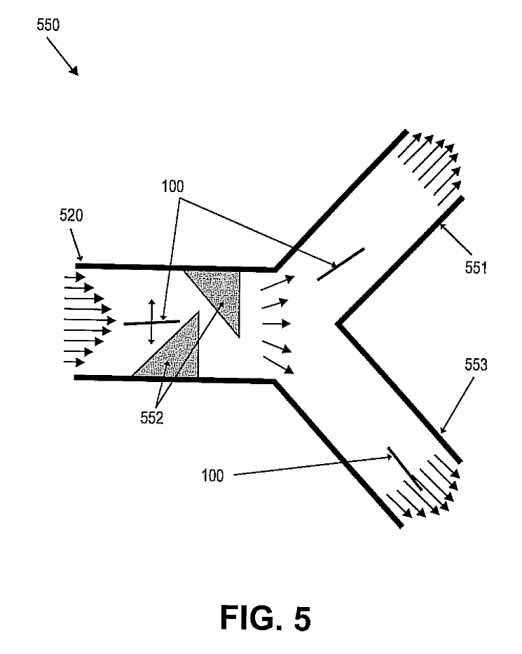

In various embodiments, the method 1000 of separating a mixture of carbon including the step 1004 of sorting the carbon nanotubes can also include directing the flow of carbon nanotubes to a plurality of collection channels 551, 553 by charged deflection plates, 552 as shown in FIG. 5. In other embodiments, the step 1004 of sorting the carbon nanotubes can also include directing the flow of carbon nanotubes to a plurality of collection channels 551, 553 by piezoelectric mechanical switch (not shown). In certain embodiments, the step 1004 of sorting the mixture of carbon nanotubes can include sorting by one or more of their length, diameter, and number of shells. One of ordinary skill in the art would know various methods of sorting the mixture of carbon nanotubes by one or more of their length, diameter, and number of shells.

FIG. 5 shows a schematic illustration of an exemplary flow-through particle sorter 550 using charged deflection plates, 552 for separating carbon nanotubes 100 according to various embodiments of the present teachings. In some embodiments, a stabilized dispersion of individually-suspended carbon nanotubes can be manipulated by an electric field gradient, wherein at low frequencies, the dielectrophoretic force on the carbon nanotubes 100 can be unidirectional, but at higher frequencies, the sign of the force depends on whether the carbon nanotubes 100 is metallic or semiconducting. Electrodes can be placed at the bottom and top (not shown) of the channel 520 that can create a nonuniform electric field gradient which can induce a dielectrophoretic response of the carbon nanotubes 100 perpendicular to the flow direction. Depending upon the carbon nanotubes type characterized in the measurement zone, either the electrode set on the left or right can be activated, thereby directing the carbon nanotubes 100 flow into the desired collection channel 551, 553.

According to various embodiments, success and optimization of the flow-through particle sorter 550 can depend upon appropriate choice of the channel size, electrode sizes and shapes, and magnitude of the electric field. For example, the carbon nanotubes can be moved a substantial distance toward the correct direction to ensure delivery to the desired collection channel 551, 553, yet should not be deflected to the point where the carbon nanotubes deposit on the electrodes placed at the bottom and top (not shown) of the channel 520. In some embodiments, the magnitude of the electric field can be from about 0.5 V/μm to about 3 V/μm.

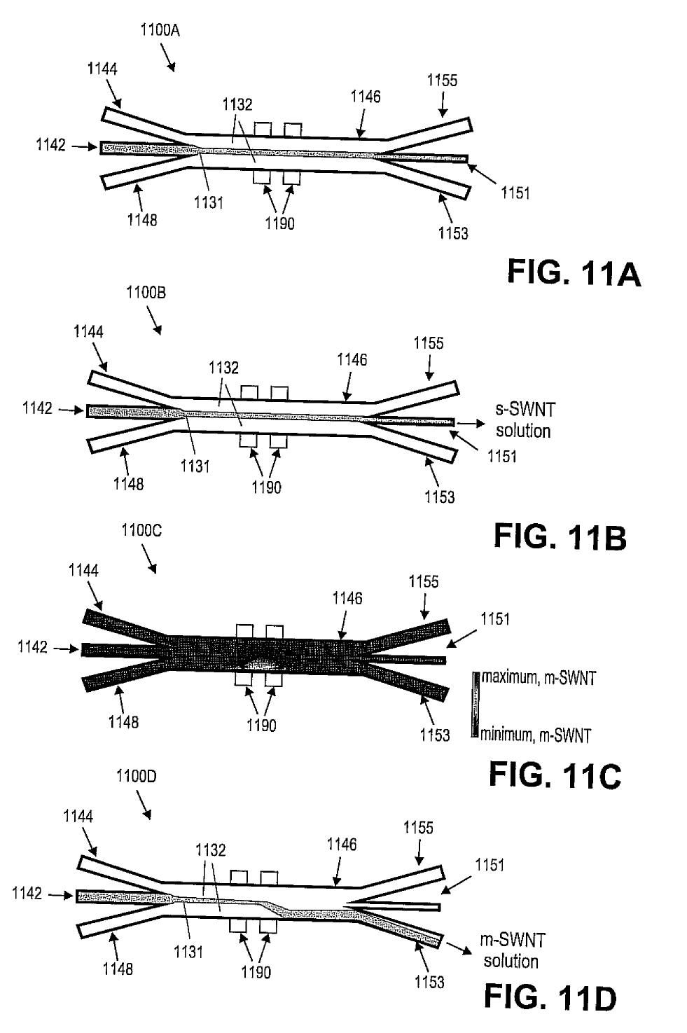

FIG. 11 shows exemplary flow-through sorter 1100A, 1100B, 1100C, 1100D for removing metallic SWNTs from the mixture of carbon nanotubes without collecting at the electrodes 1190. The exemplary flow through sorter 1100A, 1100B, 1100C, 1100D can include four channels, a first channel 1142 having a first diameter, a second channel 1144 having a second diameter, a third channel 1148 having a third diameter, and a fourth channel 1146 having a fourth diameter, wherein the first channel 1142 and the fourth channel 1146 can be at an angle to the second channel 1144 and the third channel 1148. The exemplary flow through sorter 1100A, 1100B, 1100C, 1100D can also include vertical electrodes 1190 and collection channels 1151, 1153, 1155. As mentioned before, the dielectrophoretic force on the SWNTs is unidirectional at low frequencies, but at higher frequencies the sign of the force depends on whether the carbon nanotube is metallic or semiconducting. Therefore, to separate metallic and semiconducting SWNTs, the dispersion of individually-suspended carbon nanotubes 1131 can be injected through the channel 1142 and focused into the center of the channel 1146 by the impinging flow of solvent fluid 1132 through channels 1144 and 1148, as shown in FIG. 11A. Then, a high electric field frequency can be applied, thereby causing the semiconducting SWNTs to experience a vanishing force and as a result they remain in the center of the channel 1146, as shown in FIG. 11B. On the other hand, the metallic SWNTs experience a positive dielectrophoretic force and as a result, the metallic SWNTs move towards the vertical electrodes 1190, as shown in FIG. 11C. However, the high velocity of the solvent fluid 1132 prevents the metallic SWNTs from collecting at the electrodes 1190 and therefore, the metallic SWNTs flow into the lower exit stream through the collection channel 1153.

In various embodiments, “droplet” sorting method can be used for sorting carbon nanotubes at high rates. In droplet sorting, carbon nanotubes can be encapsulated in droplets and charged prior to breakup with the fluid jet. The sign and magnitude of the charge applied to the droplet can be chosen according to measurements made upstream of the droplet. The droplet can then be steered to the collection channel using an electric field in a process similar to inkjet printing technologies. This process can require careful timing of the carbon nanotubes motions and control of the droplet formation process, but optimum performance can result in the sorting of carbon nanotubes at a rate of about 20,000 to about 40,000 counts/second. Nozzles with diameters of about 20 μm to about 50 μm can be used. Potential difficulties may arise from a number of issues with regard to the carbon nanotubes suspension, including the high aspect ratio particulates, clogging of the nozzle, and the reduced surface tension of the fluid due to the surfactant used to stabilize the suspension.

The method 1000 of separating a mixture of carbon nanotubes can further include a step (not shown) of activating a logic signal in the sorting region 550 upon characterization of the desired carbon nanotube in the measurement region 326, 426. This logic signal can be delayed until the desired carbon nanotubes reaches the point at which it can be directed to a plurality of collection channels 551, 553 by one or more of charged deflection plates 552 and piezoelectric mechanical switch (not shown). In typical cytometers, the lag time between measurement and activation of the sorting region 550 can be tens to hundreds of microseconds.

In various embodiments, non-fluorescing carbon nanotubes can be present in the carbon nanotubes dispersion and can affect the yield and throughput of the sorting system but not the purity of the collected carbon nanotubes 100 since they can be directed to waste collection or recycling stream. Examples of non-fluorescing carbon nanotubes 100 can include (i) nanotubes with surface impurities which quench fluorescence, (ii) nanotubes that are perpendicular to the polarization angle of the laser, and (iii) the metallic nanotubes. Surface impurities on carbon nanotubes can be directly related to sample preparation. These surface impurities can include organic molecules, nanotubes with oxidative damage, or even nanotube bundles. A person of ordinary skill in the art would know that centrifugation of the carbon nanotubes dispersion can remove most impurities and nanotubes bundles and can minimize their effect on detecting and sorting carbon nanotubes.

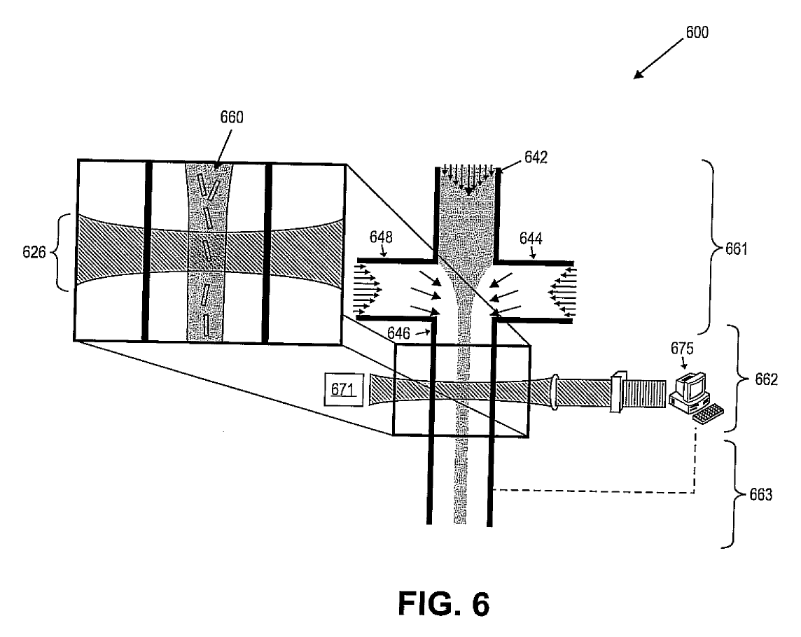

In various embodiments, the characterization in the measurement area 326, 426 can be carefully synchronized with the flow system so each individual carbon nanotubes can be detected with minimum overlap in signal output from successive carbon nanotubes in the flow stream. However, there can be simultaneous presence of two or more carbon nanotubes in the measurement region, 326, 426, 626 known as coincidence 660 and can present a problem in sorting as shown in FIG. 6. These coincidences 660 can be easily detected from the emission spectra because of the unique fluorescence of each (n,m) type. FIG. 7 shows SWNT fluorescence emission from multiple SWNT types excited with 660 nm laser. It should be noted that (7,6) and (8,3) SWNTs have high emission intensities and can be easily distinguished from other (n,m) types. In various embodiments, the sorter 550 can be operated in an abort mode where the desired carbon nanotubes and coincident carbon nanotubes are directed to waste, if the maximum purity is desired. In other embodiments, the sorter 550 can direct both carbon nanotubes types to collection, if the maximum yield is desired. In some other embodiments, two-pass sorting can be used to improve recovery of the rarest carbon nanotubes wherein the first pass can be without coincidence rejection.

According to various embodiments, there is a system 600 for separating a mixture carbon nanotubes, as shown in FIG. 6. The system 600 can include at least one hydrodynamically focused flow system 661, at least one detection system 662, and at least one collection system 663. In various embodiments, the hydrodynamically focused flow system 661 can include a first channel 642 for injecting a dispersion of individually-suspended carbon nanotubes and a second channel 644 for injecting a solvent fluid to focus the dispersion of individually-suspended carbon nanotubes into a single file stream of carbon nanotubes. In some embodiments, the hydrodynamically focused flow system 661 can further include a third channel 648 for injecting the solvent fluid, as shown in FIG. 6. In some other embodiments, the hydrodynamically focused flow system 661, 300 can include the first channel 330 at least partially disposed inside the second channel 320, as shown in FIG. 3. In other embodiments, the hydrodynamically focused flow system 661 can include an electrophoretic manipulation system (not shown). In some other embodiments, the hydrodynamically focused flow system 661 can include a dielectrophoretic manipulation system (not shown). In some embodiments, the hydrodynamic focused flow system 661 can include four channels, a first channel 642 having a first diameter, a second channel 644 having a second diameter, a third channel 648 having a third diameter, and a fourth channel 646 having a fourth diameter, wherein the first channel 642 and fourth channel 646 are at an angle to the second channel 644 and the third channel 648. In various embodiments, the at least one detection system 662 can include a multi-parameter detection system. In certain embodiments, the at least one detection system 662 can include one or more sources of excitation 671 of carbon nanotubes and one or more detectors 675. In some other embodiments, the at least one detection system 662 can include one or more of a fluorescence, a Raman, a Rayleigh, an absorption, and a Coulter counter detection system. In various embodiments, the collection system 663 can include one or more cascaded collection system (not shown). In other embodiments, the collection system 663 can include one or more charged deflection plates and piezoelectric mechanical switches.

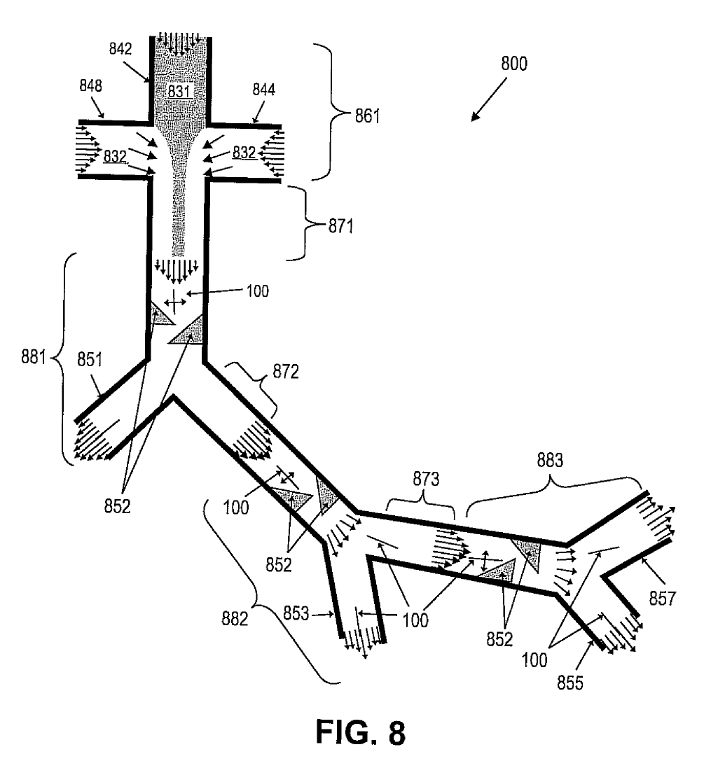

According to various embodiments, there is a system 800 for separating a mixture of carbon nanotubes including a focused flow system 861, a plurality of multi-parameter detection systems 871, 872, 873, and a plurality of cascaded collection systems 881, 882, 883, as shown in FIG. 8. In various embodiments, the focused flow system 861 can include a hydrodynamically focused flow system 861 as shown in FIG. 8. In other embodiments, the focused flow system 861 can include an electrophoretic manipulation system (not shown). In some other embodiments, the focused flow system 861 can include a dielectrophoretic manipulation system (not shown). FIG. 8 shows an exemplary system including a first multi-parameter detection system 871 followed by a first cascaded collection system 881, a second multi-parameter detection system 872 following the first cascaded collection system 881, a second cascaded collection system 882 followed by third multi-parameter detection system 873, a third cascaded collection system 883 following the third multi-parameter detection system 873, and so on. In various embodiments, each of the plurality of multi-parameter detection systems 871, 872, 873 can include one or more sources of excitation of carbon nanotubes, and one or more of a fluorescence, a Raman, a Rayleigh, an absorption, and a Coulter counter detection systems. In some embodiments, each of the plurality of cascaded collection systems 881, 882, 883 can include one or more charged deflection plates 852 and piezoelectric mechanical switches (not shown). In the system 800, a dispersion of carbon nanotubes 831 can be introduced through a first channel 842 of the focused flow system 861 and a solvent fluid 832 can be injected at an angle to the dispersion 831 through a second channel 844 and a third channel 848 to orient the carbon nanotubes 100 with the flow direction, as shown in FIG. 8. Each of the carbon nanotubes 100 can then be sorted and collected through the a series of alternate multi-parameter detection systems 871, 872, 873 and cascaded collection systems 881, 882, 883, wherein each of the plurality of cascaded collection systems 881, 882, 883 can include one or more charged plates 852 to direct each carbon nanotubes 100 motion.

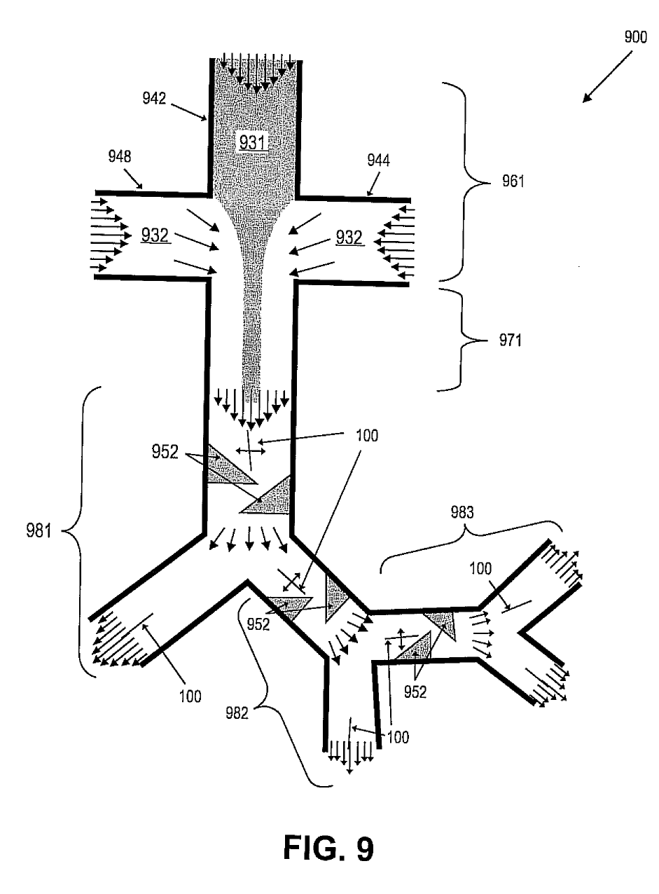

According to various embodiments, there is a system 900 for separating a mixture of carbon nanotubes including a focused flow system 961, a multi-parameter detection system 971 and a plurality of cascaded collection system 981, 982, 983, as shown in FIG. 9. In some embodiments, the focused flow system 961 can include a hydrodynamically focused flow system as shown in FIG. 9. In other embodiments, the focused flow system 961 can include an electrophoretic manipulation system (not shown). In some other embodiments, the focused flow system 961 can include a dielectrophoretic manipulation system (not shown). FIG. 9 shows an exemplary system including a multi-parameter detection system 971 followed by a first cascaded collection system 981, a second cascaded collection system 982 following the first cascaded collection system 981, a third cascaded collection system 983 following the second cascaded collection system 982, and so on. In various embodiments, the multi-parameter detection system 971 can include one or more sources of excitation of carbon nanotubes, and one or more of a fluorescence, a Raman, a Rayleigh, an absorption, and a Coulter counter detection system. In some embodiments, the cascaded collection system 981, 982, 983 can include one or more of charged deflection plates and piezoelectric mechanical switches. In the system 900, a dispersion of carbon nanotubes 931 can be introduced through a first channel 942 of the focused flow system 961 and a solvent fluid 932 can be introduced at an angle to the dispersion through a second channel 944 and a third channel 948 to orient the carbon nanotubes 100 with the flow direction, as shown in FIG. 9. In some embodiments, the dispersion of carbon nanotubes 931, 331 can be introduced through a first channel 330 of the focused flow system 961, 300 and a solvent fluid 932, 332 can be introduced through a second channel 320, such that the first channel 330 is at least partially disposed inside the second channel, as shown in FIG. 3. Each of the carbon nanotubes 100 can then be sorted and collected through the cascaded collection systems 981, 982, 983.

According to various embodiments, there is a system for separating a mixture of carbon nanotubes including a plurality of microfluidic chips, wherein each of the plurality of microfluidic chips can include a focused flow system, a detection system 662, and a collection system 663, 550, 881, 882, 883, 981, 982, 983 wherein each of the plurality of microfluidic chip detects and sorts a carbon nanotubes based on their properties. In various embodiments, the focused flow system can include a hydrodynamically focused flow system 300, 400 as shown in FIGS. 3 and 4. In other embodiments, the focused flow system can include an electrophoretic manipulation system (not shown). In some other embodiments, the focused flow system can include a dielectrophoretic manipulation system (not shown). In some embodiments, the detection system 662 of each of the plurality of microfluidic chips can include one or more sources of excitation of single walled carbon nanotubes and one or more of a fluorescence, a Raman, a Rayleigh, an absorption, and a Coulter counter detection system. In some other embodiments, the collection system 663, 550, 881, 882, 883, 981, 982, 983 of each of the plurality of microfluidic chips can include one or more of charged deflection plates 552, 852, 952 and a piezoelectric mechanical switch (not shown). In some embodiments, each of the plurality of microfluidic chip detects and sorts carbon nanotubes by specific (n,m) types. In other embodiments, each of the plurality of microfluidic chip detects and sorts carbon nanotubes by at least one of their length, their diameter, and number of shells.

While the invention has been illustrated with respect to one or more implementations, alterations and/or modifications can be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.” As used herein, the phrase “one or more of A, B, and C” means any of the following: either A, B, or C alone; or combinations of two, such as A and B, B and C, and A and C; or combinations of three A, B and C.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of separating a mixture of carbon nanotubes comprising:
dispersing carbon nanotubes into a fluid to form a dispersion of individually-suspended carbon nanotubes;
focusing the dispersion of individually-suspended carbon nanotubes into a single file stream of carbon nanotubes;
characterizing the single file stream of carbon nanotubes; and
sorting the carbon nanotubes based on their properties.

2. The method of claim 1 wherein the step of dispersing carbon nanotubes into a fluid comprises dispersing into a fluid one or both of a mixture of (n,m) single walled carbon nanotubes and a mixture of multi walled carbon nanotubes.

3. The method of claim 2 wherein the step of dispersing a mixture of (n,m) single walled carbon nanotubes into a fluid comprises dispersing a mixture of metallic single walled carbon nanotubes and semiconducting single walled carbon nanotubes into the fluid.

4. The method of claim 1 wherein the step of the focusing the dispersion of individually-suspended carbon nanotubes comprises hydrodynamic focusing.

5. The method claim 1 wherein the step of the focusing the dispersion of individually-suspended carbon nanotubes comprises auto-focusing by one or more of hydrodynamic interactions and non-Newtonian Fluid migration mechanisms.

6. The method of claim 1 wherein the step of the focusing the dispersion of individually-suspended carbon nanotubes comprises electrophoretic manipulation.

7. The method of claim 1 wherein the step of the focusing the dispersion of individually-suspended carbon nanotubes comprises dielectrophoretic manipulation.

8. The method of claim 1 wherein the step of characterizing the single file stream of carbon nanotubes comprises:
exciting each of the carbon nanotubes with an excitation source comprising a desired wavelength of light;
collecting a fluorescence signal from each of the carbon nanotubes; and
analyzing the fluorescence signal to determine one or more of (n,m) type, length, diameter, and number of shells of each of the carbon nanotubes.

9. The method of claim 8 wherein the step of characterizing the single file stream of single walled carbon nanotubes further comprises determining emission intensity threshold values and detecting a specific (n,m) type based on the emission intensity threshold values.

10. The method of claim 1 wherein the step of characterizing the single file stream of carbon nanotubes comprises:
exciting each of the carbon nanotubes with multiple sources of excitation comprising one or more of the same wavelength or different wavelength;
collecting one or more of a fluorescence signal, a Raman signal, a Rayleigh signal, and an absorption signal from each of the carbon nanotubes; and
analyzing one or more of the fluorescence signal, the Raman signal, the Rayleigh signal, and the absorption signal to determine one or more of (n,m) type, length, diameter, and number of shells of each of the carbon nanotubes.

11. The method of claim 1 wherein the step of sorting the carbon nanotubes based on their properties comprises sorting the carbon nanotubes based on one or more of specific (n,m) types, their length, their diameter, and number of shells.

12. The method of claim 1 wherein the step of sorting the carbon nanotubes comprises directing the flow of carbon nanotubes to a plurality of collection channels by one or more of charged deflection plates and piezoelectric mechanical switches.

13. The method of claim 1 further comprising separating and collecting simultaneously multiple carbon nanotubes.

14. A system for separating a mixture of carbon nanotubes comprising:
at least one hydrodynamically focused flow system, the hydrodynamically focused flow system comprising
a first channel for injecting a dispersion of individually-suspended carbon nanotubes; and
a second channel for injecting a solvent fluid to focus the dispersion of individually-suspended carbon nanotubes into a single file stream of carbon nanotubes;
at least one detection system; and
at least one collection system.

15. The system of claim 14, wherein the first channel is at least partially disposed inside the second channel.

16. The system of claim 14, wherein the hydrodynamically focused flow system further comprises a third channel for injecting the solvent fluid.

17. The system of claim 14, wherein the at least one hydrodynamically focused flow system comprises one or more of electrophoretic manipulation systems and dielectric manipulation systems.

18. The system of claim 14, wherein the at least one detection system comprises a multi-parameter detection system.

19. The system of claim 14, wherein the at least one detection system comprises:
one or more source of excitation of single wailed carbon nanotubes; and
one or more detectors.

20. The system of claim 14, wherein the at least one detection system comprises one or more of a fluorescence, a Raman, a Rayleigh, an absorption, and a Coulter counter detection system.

21. The system of claim 14, wherein the at least one collection system comprises one or more cascaded collection systems.

22. The system of claim 14, wherein at least one collection system comprises one or more piezoelectric mechanical switches and charged deflection plates.

23. A system for separating a mixture of carbon nanotubes comprising:
a plurality of microfluidic chips, wherein each of the plurality of microfluidic chips comprises a focused flow system, a detection system, and a collection system, wherein each of the plurality of microfluidic chip detects and sorts carbon nanotubes by their properties.

24. The system of claim 23, wherein the focused flow system comprises a hydrodynamically focused flow system.

25. The system of claim 23, wherein the focused flow system comprises an electrophoretic manipulation system.

26. The system of claim 23, wherein the focused flow system comprises a dielectric manipulation system.

27. The system of claim 23, wherein the detection system comprises a multi-parameter detection system.

28. The system of claim 23, wherein the collection system comprises a cascaded collection system.

29. The system of claim 23, wherein the collection system comprises one or more of charged deflection plates and a piezoelectric mechanical switch.

30. The system of claim 23, each of the plurality of microfluidic chip detects and sorts carbon nanotubes by one or more of specific (n,m) types, their length, their diameter, and number of shells.
